(19) United States
(12) Patent Application Publication
(10) Pub. No.: US 2025/0189840 A1
(43) Pub. Date: Jun. 12, 2025

(54) POLYMER MATRIX WITH MESOGENIC LIGAND AND LIGHT SHUTTER INCLUDING THE SAME

(71) Applicant: NITTO DENKO CORPORATION, Osaka (JP)

(72) Inventors: Yuran HUANG, San Diego, CA (US); Piotr POPOV, San Diego, CA (US)

(21) Appl. No.: 18/845,793

(22) PCT Filed: Mar. 24, 2023
(86) PCT No.: PCT/US2023/016213

§ 371 Date: Sep. 10, 2024

Related U.S. Application Data
(60) Provisional application No. 63/325,089, filed on Mar. 29, 2022.

(51) Int. Cl. G02F 1/1334; C09K 19/52; C09K 19/54; G02F 1/1343

(52) U.S. Cl. CPC G02F 1/1334; C09K 19/544; G02F 1/134309; G02F 1/13439; C09K 2019/521

(57) ABSTRACT

A light shutter comprising a first base element with a transparent electrode layer. a second base element with a transparent electrode layer, and a polymer matrix with improved dispersibility is disclosed. The polymer matrix comprises at least one mesogenic ligand nanoparticle complex and at least one liquid crystal compound.

### CROSS-REFERENCE TO RELATED APPLICATIONS

This application claims priority to U.S. Provisional Application No. 63/325,089, filed Mar. 29, 2022, which is incorporated by reference in its entirety.

### FIELD

The present disclosure relates to a polymer matrix with a liquid crystal compound doped with inorganic nanoparticles having mesogenic ligands on their surfaces to improve their dispersibility. Additionally, this disclosure relates to a light shutter comprising the same to reduce driving voltage in an emulsified polymer dispersed liquid crystal (PDLC).

### BACKGROUND

In the field of windows, smart windows are attractive alternatives to conventional mechanical shutters, blinds, or hydraulic methods of shading. Efforts have been made to optimize smart windows to control light waves, e.g., ultraviolet, visible, and infrared light, from passing through windows. Such control may be to provide privacy, reduce heat from ambient sunlight, and control harmful effects of ultraviolet light. Currently, polymer dispersed liquid crystals (PDLCs) are a prominent technology often utilized in smart window applications.

PDLC light shutters involve phase separation of the nematic liquid crystal from a homogenous mixture of liquid crystal and polymer disposed between two parallel substrates with transparent electrodes. The phase separated nematic liquid crystals forms micro domains/droplets dispersed within a polymer matrix. In the off state, the liquid crystals contained within these micro droplets are randomly oriented, resulting in a mismatch of their refractive indexes between the polymer matrix and the liquid crystals resulting in an opaque (light scattered state). When an external electrical field is applied to the light shutter, the liquid crystals orient such that the refractive indexes between the polymer matrix and the liquid crystals align and a transparent state results.

Disadvantages of PDLCs include the large and continuous voltages needed due to impurity ions that are often present in liquid crystal-based devices, reducing performance and efficiency. The presence of impurity ions in PDLCs can alter the devices' performance and efficiency of such liquid crystal devices. These undesired impurities are present even if the liquid crystal material was very thoroughly purified prior to its use.

Therefore, there is a need to reduce the power consumed by liquid crystal devices by lowering driving voltage and/or reducing the detrimental effects impurity ions present in liquid crystal materials and devices.

### SUMMARY OF THE DISCLOSURE

A novel approach to address the issues presented involves the addition of a mesogenic ligand nanoparticle complex to a liquid crystal composition to achieve improved dispersibility in the liquid crystal compound-resulting in a reduced driving voltage for PDLC devices. The current disclosure describes a light shutter comprising a first base element with a transparent electrode layer; a second base element with a transparent electrode layer; and a polymer matrix disposed between and in electrical communication with the first base element and the second base element.

Some embodiments include a polymer matrix. In some embodiments, the polymer matrix comprises at least one mesogenic ligand nanoparticle complex and at least one liquid crystal compound.

In some embodiments, the mesogenic ligand nanoparticle complex comprises an alkyl amine ligand or an aryl amine ligand. In some embodiments, the mesogenic ligand nanoparticle complex comprises a precious metal nanoparticle. In some embodiments, the precious metal nanoparticle comprises a gold nanoparticle. In some embodiments, the mesogenic ligand nanoparticle complex may comprise a semi-conductive material. In some embodiments, the semi-conductive material comprises indium tin oxide.

In some embodiments, the concentration of the mesogenic ligand nanoparticle complex is between about 0.01 wt % to about 5 wt % of the total weight of the polymer matrix. In some embodiments, the polymer matrix may further comprise an alkyl amine spacer or an alkyl thiol spacer. In some embodiments, the ratio of the alkyl amine spacer to the mesogenic ligand nanoparticle complex or the alkyl thiol spacer to mesogenic ligand nanoparticle complex may be between about 2:1 to about 1:2.

In some embodiments, the at least one liquid crystal compound may comprise a polymer dispersed liquid crystal. In some embodiments, the at least one liquid crystal compound comprises an emulsified polymer dispersed liquid crystal.

In some embodiments, the at least one liquid crystal compound may comprise a resin.

These and other embodiments are described in greater detail below.

### BRIEF DESCRIPTION OF THE DRAWINGS

FIG. 1 is a cross sectional view of a possible embodiment of a light shutter.

FIG. 2 is an image depicting the dispersibility of an embodiment of a mesogenic ligand.

FIG. 3 is an image depicting the dispersibility of an embodiment of a mesogenic ligand.

FIG. 4 is an image depicting the dispersibility of an embodiment of a mesogenic ligand.

FIG. 5 is a graph depicting the performance of an embodiment of a light shutter.

FIG. 6 is a graph depicting the performance of an embodiment of a light shutter.

FIG. 7 is a graph depicting the performance of an embodiment of a light shutter.

FIG. 8 is a graph depicting the performance of an embodiment of a light shutter.

FIG. 9 is a graph depicting the performance of an embodiment of a light shutter.

FIG. 10 is a graph depicting the performance of an embodiment of a light shutter.

### DETAILED DESCRIPTION

Some embodiments of the present disclosure include a light shutter comprising a polymer matrix which may be used in window type applications for energy efficiency and privacy. The polymer matrix of the present disclosure may comprise at least one mesogenic ligand nanoparticle complex and at least one liquid crystal compound. The present disclosure includes a mesogenic ligand nanoparticle complex that operates to improve the dispersibility of inorganic particles and capturing of impurity ions present within a liquid crystal medium, thus reducing the driving voltage in the light shutter. Therefore, the light shutter of the present disclosure is energy-saving. The present disclosure also describes a light shutter that can be switched between an opaque light scattering state to a transparent state by the application of an electromagnetic field.

The term “transparent” as used herein, refers to structures that do not absorb a significant amount of visible light radiation or reflect a significant amount of visible light radiation, rather, it is transparent to visible light radiation.

The term “about” as used herein, can include any numerical value that can vary without changing the basic function of that value. When used with a range, “about” also discloses the range defined by the absolute values of the two endpoints. The term “about” may refer to plus or minus 10% of the indicated number.

The term “polymer matrix” is a term of art, as used herein refers to a viscous composition or mixture of at least one mesogenic ligand nanoparticle complex and at least one liquid crystal compound. The matrix may contain solvents, crosslinkers and other polymerizable monomers.

The term “mesogenic ligand nanoparticle complex” as used herein, refers to a nanoparticle with surface conjugation of mesogenic ligands by covalent bonds.

The current disclosure includes a light shutter comprising a pair of opposing transparent electrodes. In some embodiments, the opposing transparent electrodes can define an electrode plane. Some embodiments include a light shutter, wherein the light shutter can comprise a polymer matrix. In some embodiments, the polymer matrix can be disposed between, e.g., sandwiched between, the transparent electrodes. In some embodiments, the polymer matrix can be in electrical communication with the transparent electrodes. In some embodiments, the polymer matrix can comprise at least one mesogenic ligand nanoparticle composition. In some embodiments, the polymer matrix can comprise at least one liquid crystal compound. In some embodiments, the at least one liquid crystal compound has a structure in which liquid crystals are phase-separated in the polymer matrix.

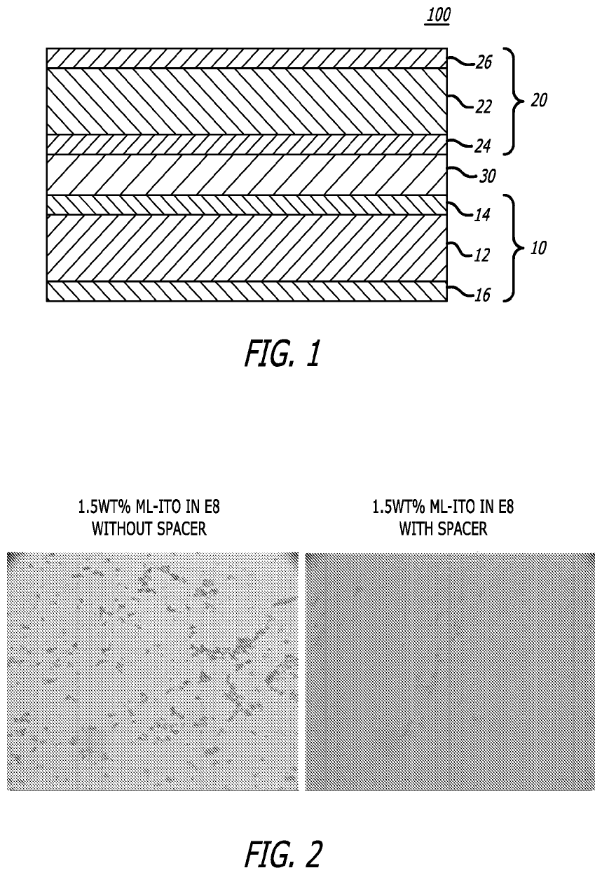

Some of the components of the light shutters of the current disclosure are described in U.S. Patent Pub. No. 2022/0035197, which is incorporated herein by reference in its entirety. An illustrative first embodiment of the light shutter of the present disclosure is shown in FIG. 1. The light shutter, such as light shutter 100, generally comprises a first base element, such as first base element 10, having a transparent electrode layer, a second base element, such as second base element 20, having a transparent electrode layer, and a polymer matrix, such as polymer matrix 30, sandwiched between the base elements 10 and 20 with transparent electrode layers and in electrical communication with the pair of opposing transparent electrodes.

In some embodiments, the first base element 10 with a transparent electrode layer comprises a first transparent base material, such as transparent base material 12, a first transparent electrode layer, such as transparent electrode layer 14, arranged on one side thereof, and a first hard coat layer, such as layer 16, arranged on the opposite side, relative to the polymer matrix 30, of the transparent base material. The first base element 10 with a transparent electrode layer may comprise a second hard coat layer (not shown) between the first transparent base material 12 and the first transparent electrode layer 14 instead of the first hard coat layer 16, or in addition to the first hard coat layer 16. In some embodiments, the first base element 10 with a first transparent electrode layer 14 may not comprise both the first hard coat layer 16 and the second hard coat layer. In some examples, the first base element 10 with a first transparent electrode layer 14 includes preferably the first hard coat layer 16, and more preferably both the first hard coat layer 16 and the second hard coat layer. In some embodiments, although not shown, an alignment film may be arranged on the surface of the transparent electrode layer in accordance with a drive mode.

The first transparent electrode layer 14 may comprise a metal oxide. The metal oxide may include, but is not limited to, indium tin oxide (ITO), zinc oxide (ZnO), or tin oxide (SnO₂). In some embodiments, the metal oxide may be an amorphous metal oxide or a crystalline metal oxide. In other embodiments, the first transparent electrode layer 14 may be formed of a metal nanowire, such as a silver nanowire (AgNW), a carbon nanotube (CNT), an organic conductive film, a metal layer, or a laminate thereof. In some embodiments, the first transparent electrode layer 14 may be patterned into a desired shape depending on the intended purposes.

The first transparent electrode layer 14 may have a thickness of preferably about 0.01 μm to about 0.1 μm, about 0.01-0.045 μm. about 0.01-0.02 μm. about 0.02-0.03 μm. about 0.03-0.04 μm. about 0.04-0.05 μm. about 0.05-0.06 μm. about 0.06-0.07 μm. about 0.07-0.08 μm. about 0.08-0.09 μm. about 0.09-0.1 μm, or any thickness in a range bounded by any of these values.

The first transparent base material 12 is not particularly limiting, and any suitable transparent base material may be utilized. In some embodiments, the first transparent base material 12 includes, but is not limited to, a glass base material, a polymer base material, or a polyethylene terephthalate (PET) base material.

In some embodiments, when the transparent base material 12 comprises the polymer base material, a polymer film containing a thermoplastic resin as a main component is typically used. Some non-limiting examples of the thermoplastic resins include, but are not limited to: a cycloolefin-based resin, such as polynorbornene; an acrylic resin; a polyester-based resin; a polycarbonate resin; and a cellulose-based resin. In some embodiments, a cycloolefin-based resin or an acrylic resin may be preferably used. Each of those resin films have relatively high brittleness while having flexibility at the same time, and thus the films can be easily snapped by bending. In some embodiments, the thermoplastic resins may be used alone or in combination.

The first transparent base material 12 has a thickness of preferably from about 20 μm to about 200 μm, about 30-100 μm, about 20-40 μm, about 40-60 μm, about 60-80 μm, about 80-100 μm, about 100-120 μm, about 120-140 μm, about 140-160 μm, about 160-180 μm, about 180-200 μm, or any thickness in a range bounded by any of these values.

The first hard coat layer 16 and the second hard coat layer may impart scratch resistance and surface smoothness to the light shutter 100. In some embodiments, the hard coat layer 16 comprises a cured layer of any suitable UV-curable resin. Non-limiting examples of the UV-curable resin comprise an acrylic resin, a silicone-based resin, a polyester-based resin, a urethane-based resin, an amide-based resin, an epoxy-based resin, or a combination thereof. In some examples, the hard coat layer may be formed by applying an application liquid comprising a monomer or an oligomer of such UV-curable resin and a photopolymerization initiator, to the first transparent base material 12, followed by drying, and irradiating the dried application layer with UV light to cure the application layer.

The hard coat layer has a thickness of preferably from 0.4 μm to 40 μm, more preferably from 1 μm to 10 μm. In one embodiment, the thickness of the hard coat layer (total thickness when the first and second hard coat layers are formed) may be set to from 1% to 20%, preferably from 2% to 15% of the thickness of the first transparent base material 12.

The haze value of the first base element 10 with a transparent electrode layer is preferably about 20% or less, more preferably about 10% or less, or still more preferably about 0.1% to 10%. The total light transmittance of the first base element 10 with a transparent electrode layer is preferably about 30% or more, more preferably about 60% or more, or still more preferably about 80% or more.

In some embodiments, the second base element 20 with a transparent electrode layer comprises a second transparent base material, such as transparent base material 22, a second transparent electrode layer, such as transparent electrode layer 24, arranged on one side thereof, and a third hard coat layer, such as layer 26, arranged on the opposite side of the transparent base material. The second base element 20 with a transparent electrode layer may comprise a fourth hard coat layer (not shown) between the second transparent base material 22 and the second transparent electrode layer 24 instead of, or in addition to, the third hard coat layer 26. In some embodiments, the second base element 20 with a second transparent electrode layer 24 may not comprise both the third hard coat layer 26 and the fourth hard coat layer. In some examples, the second base element 20 with a second transparent electrode layer 24 includes preferably the third hard coat layer 26, and more preferably both the third hard coat layer 26 and the fourth hard coat layer. In some embodiments, although not shown, an alignment film may be arranged on the surface of the transparent electrode layer in accordance with a drive mode.

The haze value of the second base element 20 with a transparent electrode layer is preferably about 20% or less, more preferably about 10% or less, and still more preferably from about 0.1% to about 10%. The total light transmittance of the second base element 20 with a transparent electrode layer is preferably about 30% or more, more preferably about 60% or more, or still more preferably about 80% or more.

The same description as detailed above for the first transparent electrode layer 14, the first transparent base material 12, the first hard coat layer 16, and the second hard coat layer may be applied to the second transparent electrode layer 24, the second transparent base material 22, the third hard coat layer 26, and the fourth hard coat layer, respectively. The second base element 20 with a transparent electrode layer may have the same configuration as that of the first base element 10 with a transparent electrode layer or may have a different configuration.

In some embodiments, the light shutter 100 comprises a polymer matrix 30. In some embodiments, the polymer matrix 30 comprises at least one mesogenic ligand nanoparticle complex and at least one liquid crystal compound.

In some embodiments, the mesogenic ligand of the mesogenic ligand nanoparticle complex may comprises an alkyl amine ligand and/or aryl amine ligand. In some embodiments, the mesogenic ligand may comprise a substituted aryl group. In some embodiments, the substituted aryl group may comprise an amino functional group. In some embodiments, the substituted aryl group may comprise a C₂ to C₁₂ alkoxy group. In some embodiments the substituted aryl group may be a substituted 1,1′-biphenyl]-4-carbonitrile. In some embodiments, the substituted 1,1′-biphenyl]-4-carbonitrile may have the formula:

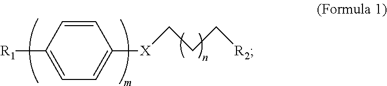

wherein R₁ may be

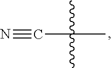 [SMILES: *C#N]

—H, or —F; wherein m may be 2-4 (e.g., 2 aryl groups); wherein X may be —O— or —S—; n may be about 5 to about 15 (e.g., 10); and wherein R₂ may be —COOH, —C═CH₂, —OH; —SH, —NH₂, —N₃, or any functional group suitable for facilitating covalent bonding with the respective selected nanoparticle described below.

In another embodiment, the mesogenic ligand of the mesogenic nanoparticle complex may comprise the formula:

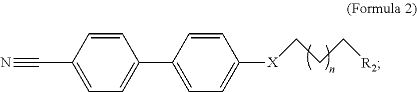

wherein X may be —O— or —S—; wherein n may be between about 5 to about 15 (e.g., 10); and R is independently selected from —COOH, —C═CH₂, —OH; —SH, —NH₂, and/or —N₃. In some embodiments, the mesogenic ligand nanoparticle may comprise:

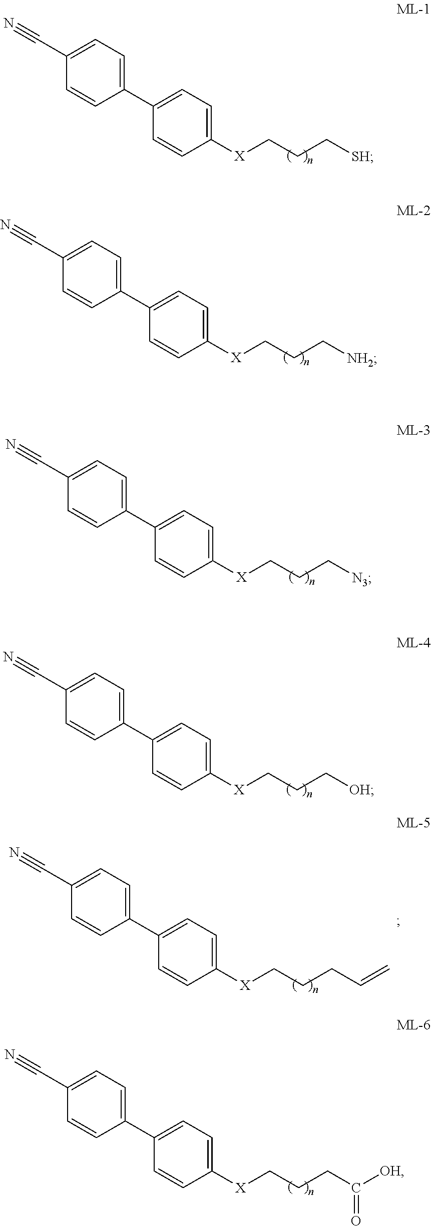

or any combination thereof, wherein n and X are as defined above.

In some embodiments, the mesogenic ligand of the mesogenic ligand nanoparticle complex can comprise a substituted aryl group or a substituted cyclohexyl group. In some embodiments, the substituted aryl group can be a substituted 1,1′-biphenyl. In some embodiments, the mesogenic ligand nanoparticle complex may comprise:

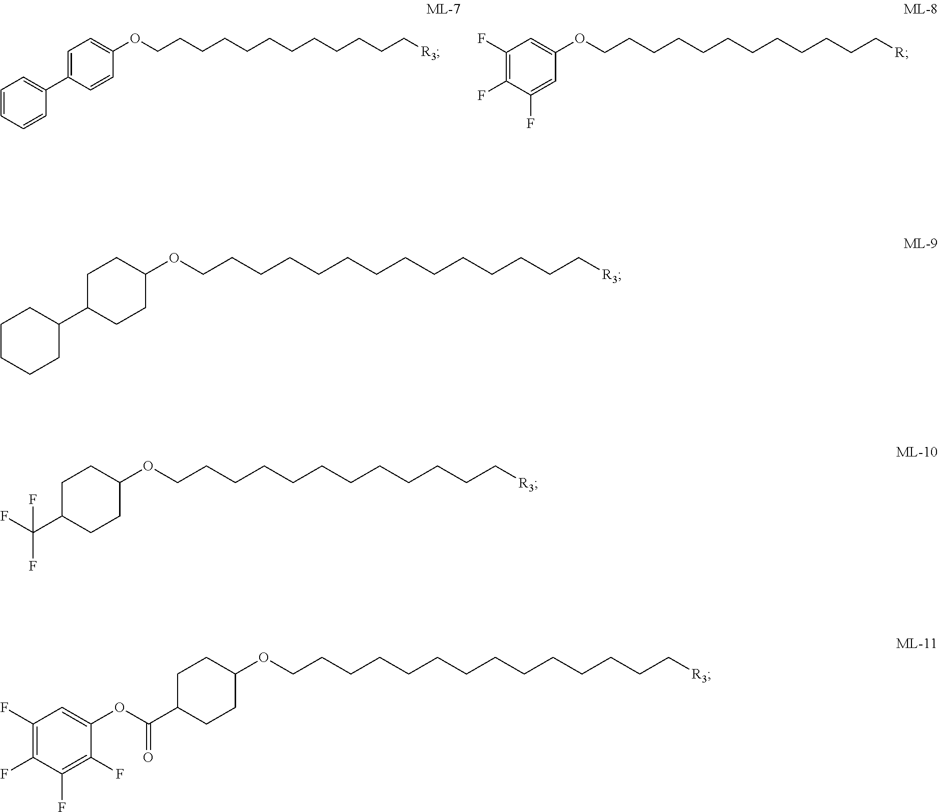

or any combination thereof; wherein R₃ may be —COOH, —C═CH₂, —OH; —SH, —NH₂, —N₃, or any functional group suitable for facilitating covalent bonding with the respective selected nanoparticle.

In some embodiments, the polymer matrix 30 may comprise a plurality of spacers. In some embodiments, the polymer matrix 30 may comprise an alkyl amine spacer. In some embodiments, the alkyl amine spacer may comprise a C₃-C₁₂ alkyl amine, e.g., hexylamine

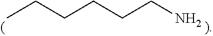

In some embodiments, the length the carbon chain of the alkyl amine spacer may be 3, 4, 5, 6, 7, 8, 9, 10, 11, or 12 carbon atoms.

In some embodiments, the polymer matrix 30 may comprise an alkyl thiol spacer. In some embodiments, the alkyl thiol spacer may comprise a C₃-C₁₂ alkyl thiol, e.g., hexanethiol

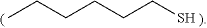

In some embodiments, the length the carbon chain of the alkyl thiol spacer may be 3, 4, 5, 6, 7, 8, 9, 10, 11, or 12 carbon atoms.

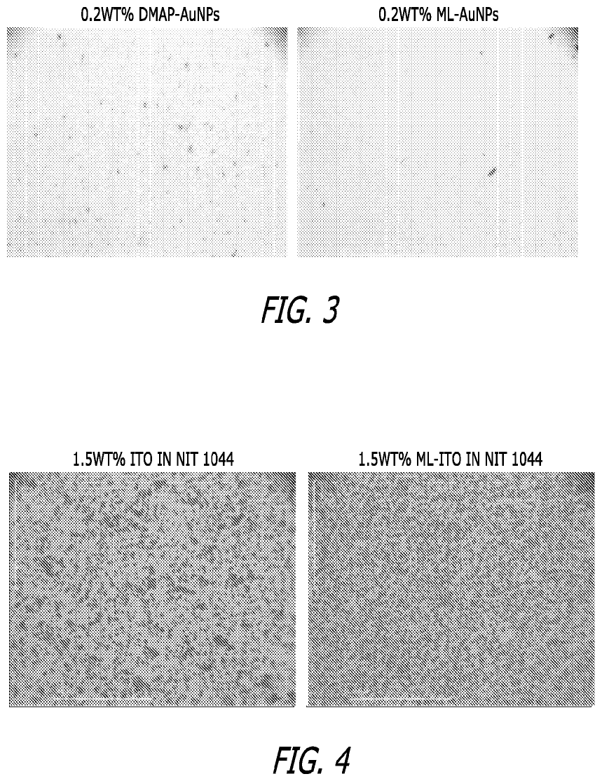

In some embodiments, the length of the spacer may be selected to improve the dispersity of the mesogenic ligand nanoparticle complex in the liquid crystal compound. The length of the spacer may also or alternatively be selected based upon the type of liquid crystal and selection of a functional group. As shown in FIG. 2, a mesogenic ligand nanoparticle complex comprising a spacer can achieve improved dispersibility in the liquid crystal compound. A polymer matrix 30 without the surface modification of a mesogenic ligand nanoparticle complex may increase the aggregation and phase separation in the liquid crystal compound as depicted in FIG. 3. As can be seen in FIG. 4, dispersibility can be further improved with an emulsified liquid crystal compound.

In some embodiments, the relative amounts of the components may be adjusted to improve the dispersibility of the mesogenic ligand nanoparticle complex in the liquid crystal compound. In some embodiments, the relative molar amounts of the mesogenic ligand to the alkyl amine spacer can be between about 2:1 to about 1:2 (e.g. 1:1). In some embodiments, the relative molar amounts of the mesogenic ligand to the alkyl thiol spacer can be between about 2:1 to about 1:2 (e.g. 1:1).

In some embodiments, the mesogenic ligand nanoparticle complex comprises a nanoparticle. In some embodiments, the nanoparticle is covalently bound to the aforementioned mesogenic ligands and/or analogues thereof. In some embodiments, the nanoparticle can be conductive. In some embodiments, the nanoparticle can comprise a metal. In some embodiments, the nanoparticle can be a precious metal nanoparticle. In some embodiments, the precious metal nanoparticle can comprise gold, silver, or platinum nanoparticles, or a combination thererof. In some embodiments, the nanoparticle can comprise a semi-conductive material. In some embodiments, the semi-conductive material may be indium tin oxide (ITO), zirconium dioxide (ZiO₂), titanium dioxide (TiO₂), or a combination thereof. In some embodiments, the nanoparticle can comprise a ferroelectric material. In some embodiments, the ferroelectric material can be BaTiO₃. In some embodiments, the aforementioned nanoparticles can have an average diameter of about 50 nm to about 70 nm, about 50-55 nm, about 55-60 nm, about 60-65 nm, about 65-70 nm, or about 60 nm, or any average diameter in a range bounded by any of these values. In some embodiments, the nanoparticle is selected for its conductive and ferroelectric properties. In some embodiments, the nanoparticle is selected due to the ability to adapt to the mesogenic ligand for conjugation. In some embodiments, —SH is suitable for and easily conjugates with a gold nanoparticle, and —NH₂ is suitable for and easily conjugates with an indium tin oxide nanoparticle.

In some embodiments, the mesogenic ligand nanoparticle complex is selected due to the ability to improve the dispersibility of inorganic nanoparticles in a liquid crystal composition. Inorganic nanoparticles may be characterized as having the capability to reduce the driving voltage of a device by capturing impurity ions that are often present within a liquid crystal composition. By increasing the dispersibility of inorganic nanoparticles, the number of impurity ions captured by inorganic nanoparticles increases, which in turn may further decrease the driving voltage of the device.

In some embodiments, the mesogenic ligand nanoparticle complex comprises an interactive terminal end group. In some embodiments, the interactive terminal end group can comprise

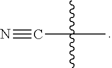 [SMILES: *C#N]

It is believed that the interactive terminal end group enables the ionic group to interact, e.g., adsorb and/or bond with the impurity ions dispersed within the polymer matrix 30, e.g., inorganic ions otherwise present or generated within the matrix, e.g., Na⁺, NH₄⁺, K⁺, Mg²⁺, Ca²⁺, Zn²⁺, Al₃⁺, F⁻, Cl⁻, NO₃⁻, NO₂⁻, Br, and/or SO₄²⁻. In some embodiments, the mesogenic ligand nanoparticle complex can comprise a saturated or unsaturated aryl group, e.g., the terminal end group can be a hydrogen group.

In some embodiments, the wt % of the mesogenic ligand nanoparticle complex can be in the range of about 0.001 wt % to about 10 wt % of the total weight of the polymer matrix 30, or about 0.01 wt % to about 10 wt %, about 0.1 wt % to about 10 wt %, about 0.01 wt % to about 1 wt %, about 1 wt % to about 2 wt %, about 2 wt % to about 3 wt %, about 3 wt % to about 4 wt %, about 4 wt % to about 5 wt %, about 5 wt % to about 6 wt %, about 6 wt % to about 7 wt %, about 7 wt % to about 8 wt %, about 8wt % to about 9 wt %, about 9 wt % to about 10 wt %, or about 0.001 wt %, about 0.01 wt %, about 0.1 wt %, about 1 wt %, about 2 wt %, about 3 wt %, about 4 wt %, about 5 wt %, about 6 wt %, about 7 wt %, about 8 wt %, about 9 wt %, about 10 wt %, or any wt % that is in a range bounded by any of these.

In some embodiments, the polymer matrix 30 can comprise at least one liquid crystal compound. The polymer matrix 30 can be prepared by any appropriate method. In some embodiments, the polymer matrix 30 may be obtained by mixing and stirring a liquid crystal compound in a dispersed phase and a water-soluble polymer (aqueous phase) or matrix-forming resin (latex) dissolved in water. Details of the preparation of the liquid crystal compound are described in, for example, U.S. Patent Pub. No. 2022/0035197, U.S. Patent Pub. No. 2021/0394504, PCT Pub. No. WO2021065731, Japan Patent No. 07019315, all of which are incorporated herein by reference in their entirety.

Some embodiments include a method for producing an emulsion-type PDLC layer (e.g., the polymer matrix 30) comprising forming a coating layer by applying an emulsion coating liquid containing a polymer resin and a liquid crystal compound to the transparent electrode layer surface of one of the transparent conductive films, and drying the coating layer to form a polymer resin matrix on the electrode. In some embodiments, the emulsion coating liquid is preferably an emulsion containing a mixed solution of a polymer resin and a coating solvent in a continuous phase and a liquid crystal compound in a dispersed phase. By coating and drying the emulsified coating liquid, a PDLC layer having a structure in which a liquid crystal compound is dispersed in a resin matrix can be formed. In some examples, a PDLC element is obtained by laminating the other transparent conductive film on the PDLC layer.

Any suitable liquid crystal compound may be used. In some embodiments, the at least one liquid crystal compound can comprise a smectic liquid crystal compound. In some embodiments, the at least one liquid crystal compound can comprise a cholesteric liquid crystal compound. In some embodiments, the at least one liquid crystal compound can comprise a polymer dispersed liquid crystal compound. In some embodiments, the polymer dispersed liquid crystal compound comprises an emulsified polymer dispersed liquid crystal.

In another embodiment, the at least one liquid crystal compound may comprise a nematic liquid crystal compound. A nematic liquid crystal compound is preferably used because of excellent transparency properties. Examples of the nematic liquid crystal compounds include biphenyl compounds, phenylbenzoate compounds, cyclohexylbenzene compounds, azoxybenzene compounds, azobenzene compounds, azomethine compounds, terphenyl compounds, biphenylbenzoate compounds, cyclohexylbiphenyl compounds, phenylpyridine compounds, cyclohexylpyrimidine compounds, cholesterol compounds, and the like.

In some embodiments, the at least one liquid crystal compound may comprise a resin. Any suitable resin may be used in the liquid crystal compound. For example, a polyurethane resin, a polyethylene resin, a polypropylene resin, a polyacrylic resin, and the like can be used. A water-soluble polymer such as a methacrylate/acrylonitrile copolymer, a urethane/acrylate copolymer, or an acrylate/acrylonitrile copolymer may also be used.

The total amount of the liquid crystal compound and the resin is preferably about 30 parts by weight to about 70 parts by weight and more preferably about 40 parts by weight to about 60 parts by weight with respect to 100 parts by weight of the polymer matrix 30. If it is in such a range, a stable emulsion coating liquid may be obtained.

In some embodiments, the relative weight amount of the liquid crystal compound to the resin (resin/liquid crystal compound) may be about 10/90, about 20/80, about 30/70, about 40/60, about 50/50, about 60/40, about 70/30, about 80/20, or about 90/10, and more preferably about 30/70 to about 70/30. It is believed that if the proportion of the liquid crystal compound is too large, the liquid crystal emulsion may become unstable, and the droplet size may become coarse over time.

The liquid crystal compound may further contain a crosslinking agent. If the crosslinking agent is used, the polymer matrix 30 can form a crosslinked structure. Any suitable crosslinking agent may be used as the crosslinking agent. Non-limiting examples of crosslinking agents include an aziridine type crosslinking agent, an isocyanate type crosslinking agent, and the like. The wt % of the crosslinking agent may be about 0.5 wt % to about 10 wt %, about 0.5-1 wt %, about 1-5 wt %, about 5-10 wt %, about 0.8 to 5 wt %, or any wt % in a range bounded by any of these values, with respect to 100 parts by weight of the polymer matrix 30.

The viscosity of the polymer matrix 30 is preferably about 20 mPas to about 400 mPas, more preferably about 30-300 mPas or even more preferably about 40-200 mPas at the time of filling the light shutter 100. It is believed that when the viscosity is less than 20 mPas, convection of the solvent increases when the solvent (water) is dried, and the thickness of the polymer matrix 30 may become unstable. It is also believed that when a viscosity exceeds 400 mPas, there exists a possibility that the bead of a polymer matrix 30 may not be stabilized. The viscosity of the polymer matrix 30 can be measured with a rheometer MCR302 manufactured by Anton Paar. The value of the shear viscosity of the present disclosure is determined at 20° C. and a shear rate of 1000 per second is used.

Some examples of liquid crystal compounds that can be used in the present light shutter 100 include, but are not limited to, E7, E8, E44, QY-PDLC8, MLC-2109, MLC-2125, MLC-2132, MLC-2133, MCL-2134 MLC-15600-000, MLC-15600-100, MLC-3003, MLC-3012, and MLC-3016 (Merck KGaA, Germany), NIT1044 (Nitto Denko Corporation), or JM1000XX (Chisso Corporation, Japan). The concentration of the at least one liquid crystal compound can be calculated by subtracting the total amount of chiral dopant[s], reactive mesogen composition[s], and the UV photo-initiator[s] from 100. The wt % of the at least one liquid crystal compound may be in the range of about 50 wt % to about 99 wt % of the total weight of the polymer matrix 30, or about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, about 95 wt % to about 99 wt %, about 52 wt %, about 53 wt %, about 54 wt %, about 71 wt %, about 72 wt %, about 73 wt %, about 74 wt %, about 82 wt %, about 83 wt %, about 84 wt %, about 85 wt %, about 86 wt %, about 87 wt %, about 88 wt %, or any wt % that is in a range bounded by any of these values.

In some embodiments, the polymer matrix 30 may comprise a reactive mesogen composition. In some embodiments, the reactive mesogen composition can comprise at least one reactive mesogen. In some embodiments, the reactive mesogen composition comprises at least one polymerizable monomer. In some embodiments, the reactive mesogen composition may comprise a photo-initiator. In some embodiments, the at least one reactive mesogen can be LC242 (BASF, Germany). In some embodiments, the at least one reactive mesogen can be RM257 (Merck KGaA, Germany). The choices of reactive mesogen compositions or polymerizable monomer is not particularly limiting and any suitable mesogen composition or polymerizable monomer may be used.

In some embodiments, the at least one reactive mesogen composition can have a concentration of the total weight of the polymer matrix 30 in the range of about 0.1 wt % to about 40 wt %. In a more preferred embodiment, the at least one reactive mesogen composition can have a concentration between about 1 wt % to about 35 wt %. In still a more preferred embodiment, the at least one reactive mesogen composition can have a concentration between about 4 wt % to about 15 wt %. The at least one reactive mesogen composition can be about 0.1 wt % to about 1 wt %, about 1 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, or any wt % in a range bounded by any of these values.

In some embodiments, the polymer matrix 30 of the light shutter 100 may comprise a photo-initiator. In some embodiments, the photo-initiator can be an Ultra Violet (UV) photo-initiator. In some embodiments, the UV photo-initiator can comprise IrgaCure® 651 or Irgacure® TPO (BASF Chemical Co., Ludwigshafen, Germany). The selection of a photo-initiator is not limited, the photo-initiator can be a UV or a heat activated initiator, etc., and any suitable photo-initiator may be selected depending on the application of the light shutter 100.

The wt % of the UV photo-initiator is the wt % with respect to the total weight of the at least one reactive mesogen, thus 1 wt % is 1% of the total amount of the at least one reactive mesogen (e.g., if the UV photo-initiator is 1 wt % and the at least one reactive mesogen is 4.7 wt % then the UV photo-initiator is 1% of the 4.7 wt % or 0.047 wt % of the total weight of the polymer matrix 30). The wt % of the UV photo-initiator with respect to the total weight of the at least one reactive mesogen can be in the range of about 0.035 wt % to about 5 wt %, about 0.03 wt % to about 4 wt %, about 0.035 wt % to about 3 wt %, about 0.4 wt % to about 2 wt %, about 0.5 wt % to about 1 wt %, about 0.1 wt %, about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.85 wt %, about 0.9 wt %, about 0.95 wt %, about 1 wt %, about 2 wt %, about 3 wt %, about 4 wt %, about 5 wt %, or any wt % in a range bounded by any of these values.

The light shutters described herein are useful in methods for controlling the amount of light and/or heat passing through a window. The light shutters described herein may further be useful in efforts to provide privacy, reduce heat from ambient sunlight, and control harmful effects of ultraviolet light.

As used herein, unless otherwise specified the use of the ordinal adjectives “first” and “second,” to describe a common object, merely indicate that different instances of like objects are being referred to, and are not intended to imply that the objects so described must be in a given sequence, either temporally, spatially, in ranking, or in any other manner.

Use of the term “may” or “may be” should be construed as shorthand for “is” or “is not” or, alternatively, “does” or “does not” or “will” or “will not,” etc. For example, the statement “a thermally conductive composite may further comprise a backing layer” should be interpreted as, for example, “In some embodiments, a thermally conductive composite further comprises a backing layer,” or “In some embodiments, a thermally conductive composite does not further comprise a backing layer.”

Unless otherwise indicated, all numbers expressing quantities of ingredients, properties, such as, molecular weight, reaction conditions, and so forth used in the specification and embodiments are to be understood as being modified in all instances by the term “about.” The term “about” as used herein, can include any numerical value that can vary without changing the basic function of that value. When used with a range, “about” also discloses the range defined by the absolute values of the two endpoints. The term “about” may refer to plus or minus 10% of the indicated number.

Accordingly, unless indicated to the contrary, the numerical parameters set forth in the specification and attached embodiments are approximations that may vary depending upon the desired properties sought to be obtained. At the very least, and not as an attempt to limit the application of the doctrine of equivalents. To the scope of the embodiments, each numerical parameter should at least be construed in light of the number of reported significant digits and by applying ordinary rounding techniques.

For the processes and/or methods disclosed, the functions performed in the processes and methods may be implemented in differing order, as may be indicated by context. Furthermore, the outlined steps and operations are only provided as examples and some of the steps and operations may be optional, combined into fewer steps and operations, or expanded into additional steps and operations.

This disclosure may sometimes illustrate different components contained within, or connected with, different other components. Such depicted architectures are merely examples, and many other architectures may be implemented which achieve the same or similar functionality.

The terms used in this disclosure and in the appended embodiments, (e.g., bodies of the appended embodiments) are generally intended as “open” terms (e.g., the term “including” should be interpreted as “including, but not limited to,” the term “having” should be interpreted as “having at least,” the term “includes” should be interpreted as “includes, but not limited to,” etc.). In addition, if a specific number of elements is introduced, this may be interpreted to mean at least the recited number, as may be indicated by context (e.g., the bare recitation of “two recitations,” without other modifiers, means at least two recitations of two or more recitations). As used in this disclosure, any disjunctive word and/or phrase presenting two or more alternative terms should be understood to contemplate the possibilities of including one of the terms, either of the terms, or both terms. For example, the phase “A or B”: will be understood to include the possibilities of “A” or “B” or “A and B.”

The terms “a,” “an,” “the” and similar referents used in the context of describing the present disclosure (especially in the context of the following embodiments) are to be construed to cover both the singular and the plural, unless otherwise indicated herein or clearly contradicted by context. The use of any and all examples, or representative language (e.g., “such as”) provided herein is intended merely to better illuminate the present disclosure and does not pose a limitation on the scope of any embodiments. No language in the specification should be construed as indicating any non-embodied element essential to the practice of the present disclosure.

Groupings of alternative elements or embodiments disclosed herein are not to be construed as limitations. Each group member may be referred to and embodied individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended embodiments.

Certain embodiments are described herein, including the best mode known to the inventors for carrying out the present disclosure. Of course, variations on these described embodiments, will become apparent to those of ordinary skill in the art upon reading the foregoing description. The inventor expects skilled artisans to employ such variations as appropriate, and the inventors intend for the present disclosure to be practiced otherwise than specifically described herein. Accordingly, the embodiments include all modifications and equivalents of the subject matter recited in the embodiments as permitted by applicable law. Moreover, any combination of the above-described elements in all possible variations thereof is contemplated unless otherwise indicated herein or otherwise clearly contradicted by context. In closing, it is to be understood that the embodiments disclosed herein are illustrative of the principles of the embodiments. Other modifications that may be employed are within the scope of the embodiments. Thus, by way of example, but not of limitation, alternative embodiments may be utilized in accordance with the teachings herein. Accordingly, the embodiments are not limited to the embodiments precisely as shown and described.

Hereinafter, embodiments and methods will be described in more detail.

### Embodiments

Embodiment 1 A light shutter comprising:
a first base material with a transparent electrode layer;
a second base material with a transparent electrode layer; and
a polymer matrix comprising at least one mesogenic ligand nanoparticle complex and at least one liquid crystal compound, wherein the polymer matrix is disposed between the first base material and the second base material.

Embodiment 2 The light shutter of embodiment 1, the mesogenic ligand nanoparticle complex comprising an alkyl amine ligand or an aryl amine ligand.

Embodiment 3 The light shutter of embodiment 2, the mesogenic ligand nanoparticle complex comprising a ligand of the general formula:

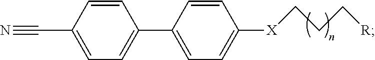

wherein X can be —O— or —S—, wherein n can be between about 5 to about 15, wherein R is independently selected from —COOH, —C═CH₂, —OH, —SH, —NH₂, and/or —N₃.

Embodiment 4 The light shutter of embodiment 2, the mesogenic ligand nanoparticle comprising one of the following structures:

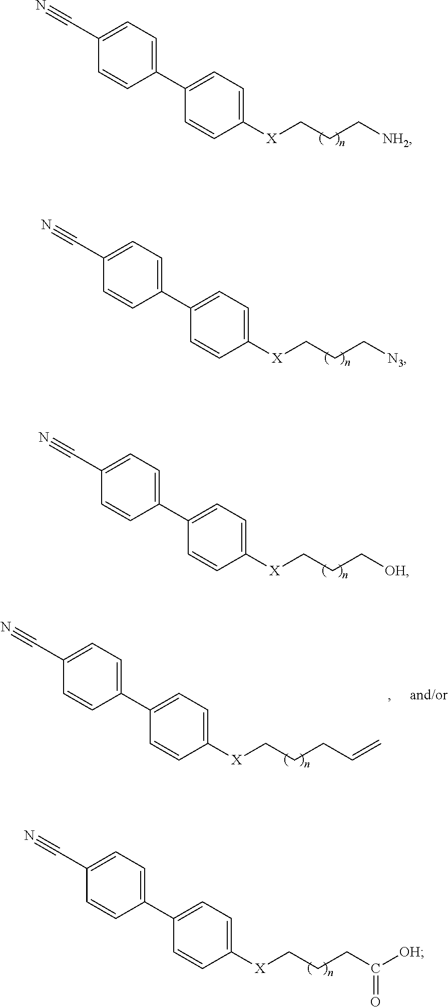

wherein n can be between about 5 to about 15, and wherein X can be —O— or —S—.

Embodiment 5 The light shutter of embodiment 1, the mesogenic ligand nanoparticle complex comprising one of the following formula:

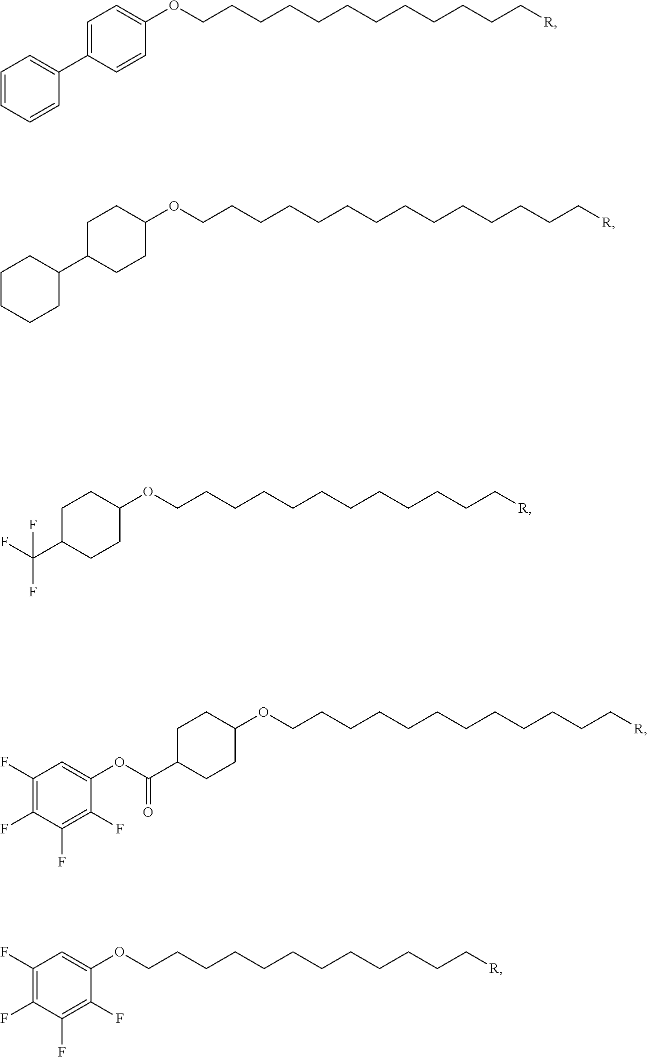

or combinations thereof, wherein R is independently selected from —COOH, —C═CH₂, —OH, —SH, —NH₂, and/or —N₃.

Embodiment 6 The light shutter of embodiment 1, the mesogenic ligand nanoparticle complex comprising a precious metal nanoparticle.

Embodiment 7 The light shutter of embodiment 6, the precious metal nanoparticle comprising a gold nanoparticle.

Embodiment 8 The light shutter of embodiment 1, the mesogenic ligand nanoparticle complex comprising a semi-conductive material.

Embodiment 9 The light shutter of embodiment 8, the semi-conductive material comprising indium tin oxide.

Embodiment 10 The light shutter of embodiment 1, wherein the concentration of the mesogenic ligand nanoparticle complex is between about 0.01 wt % to about 5 wt % of the total weight of the polymer matrix.

Embodiment 11 The light shutter of embodiment 1, the polymer matrix further comprising an alkyl amine spacer or an alkyl thiol spacer, wherein the ratio of the alkyl amine spacer to the mesogenic ligand nanoparticle complex or the alkyl thiol spacer to mesogenic ligand nanoparticle complex is between about 2:1 to about 1:2.

Embodiment 12 The light shutter of embodiment 1, the at least one liquid crystal compound comprising a polymer dispersed liquid crystal.

Embodiment 13 The light shutter of embodiment 1, the at least one liquid crystal compound comprising an emulsified polymer dispersed liquid crystal.

Embodiment 14 The light shutter of embodiment 1, the at least one liquid crystal compound comprising a resin.

### EXAMPLES

It has been discovered that embodiments of the light shutter comprising the polymer matrix as described herein have improved performance as compared to other forms of light shutters. These benefits are further demonstrated by the following examples, which are intended to be illustrative of the disclosure only but are not intended to limit the scope or underlying principles in any way.

### Synthesis of Mesogenic Ligand-Nanoparticle

Different types of mesogenic ligands were synthesized to specifically conjugate on surfaces of different nanoparticles. Here we use thiol-mesogenic ligands to gold nanoparticle and amine-mesogenic ligands to ITO nanoparticles as examples.

### Synthesis of Mesogenic Ligands (ML-1):

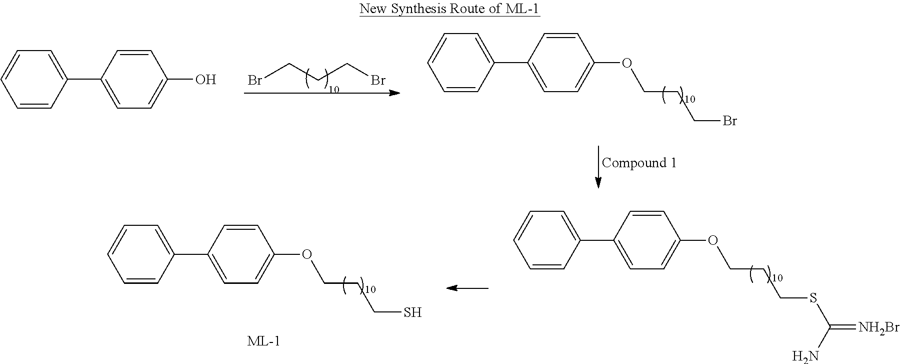

4′-Phenylphenol (1.0 eq), 1,12-Dibromododecane (3.0 eq) and K₂CO₃ (3.0 eq) were placed in a one neck round bottom flask with acetone under stirring. The resulting suspension was heated at reflux for over 20 hours, then was under vacuum. The obtained solid was dispersed in dichloromethane (DCM), then washed with Di-H₂O to remove remained salts. The filtrate was concentrated under reduced pressure, then purified with column chromatography (1:1 Dichloromethane-hexane) to give desired Compound 1.

A solution of Compound 1 (1.0 eq) with 50 mM in anhydrous ethanol, and thiourea (2.3 eq) were refluxed for 20 hours. The solids were filtered after the solution was cooled to room temperature, and then crystalized from hot ethanol to give desired Compound 2.

Compound 2 (1.0 eq. 42 mM) and potassium hydroxide (KOH, 1.3 eq) were dispersed in mixture of ethanol and water with volume ratio mass 1:3. The reaction mixture was refluxed under Argon protection for 7 hours. After cooled to room temperature, the mixture was acidified with concentrated acetic acid to pH=4 and stirred for another 2 hours. The mixture was concentrated under reduced pressure to give white residue. The residue was partitioned between dichloromethane and water. The organic layer was collected and dried over CaCl₂, and then concentrated to give desired ML-1.

Water dispersible gold nanoparticles with 4-(N,N-dimethylamino)pyridine (DMAP) were synthesized for further mesogenic ligands conjugation. Hydrogen tetrachloroaurate was dissolved in 80 ml water with concentration as 32 mM. Tetraoctylammonium bromide was dissolved in 200 ml toluene with concentration as 56 mM under sonication, and then added into previous gold solution under vigorous stirring. After 30 min reaction, the gold had transferred to the organic phase. Then, 60 ml sodium borohydride aqueous solution with concentration as 661 mM was added dropwise to the mixture, to give violet-brown color within minutes, and stirred vigorously overnight. The organic layer was separated and washed with water to give a resultant purple solution. Then the purple solution was diluted to 500 ml with toluene and transferred to a 2-liter funnel. 500 ml 50 mM DMAP aqueous solution was carefully poured into the funnel. The bottom aqueous layer was removed and diluted to 500 ml, and then stored at 4° C. for future use. 25 ml aqueous AuNPs solution was freeze-dried and then weighted to give concentration of gold as 0.3 mg/ml.

Synthesized ML-1 and 1-hexanethiol was dissolved in acetone with concentration as 0.3 mM. 50 ml of the DMAP-AuNPs solution was directly added into 20 ml of the above solution under vigorously stirring. After overnight, the dark precipitate formed in the reaction mixture was separated by centrifuge (12000 rpm, 10 min, 10° C.). Then the nanoparticles were re-dispersed in a minimal quantity of dichloromethane, and precipitated with cooled ethanol, and then separated by centrifuge (12000 rpm, 10 min, 10° C.). This step was repeated over 4 times until the excess mesogenic ligands were removed. The isolated nanoparticles (also referred to as “ML-Au” in the accompanying figures) were dried and stored under room temperature for further use.

### Synthesis of Mesogenic Ligands (ML-2):

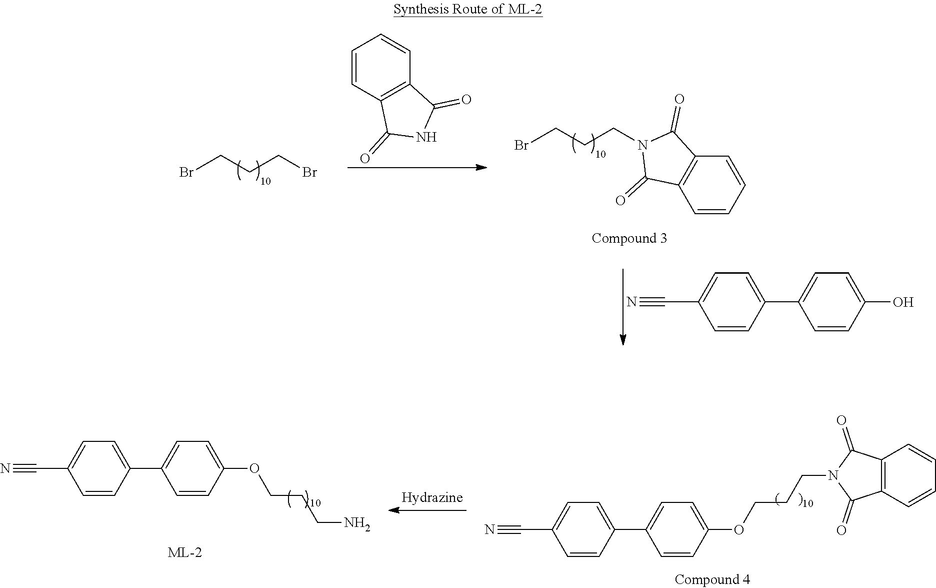

Phthalimide (1.0 eq), 1,12-Dibromododecane (3.0 eq) and K₂CO₃ (3.0 eq) were placed in a one neck round bottom flask with acetone under stirring. The resulting suspension was heated at reflux for over 20 hours, then was concentrated under vacuum. The obtained solid was dispersed in DCM, then washed with Di-H₂O to remove remaining salts. The filtrate was concentrated under reduced pressure, then purified with column chromatography (1:3 ethyl acetate-hexane) to give desired Compound 3.

Compound 3 (1.0 eq), and 4′-hydroxybiphenyl 4-carbonitrile (2.0 eq) and K₂CO₃ (3.0 eq) were dispersed in acetone and refluxed at a temperature of 60° C. for over 20 hours. After concentrated under a reduced pressure of about −80 kPa to about −90 kPa, the obtained solid was dispersed in DCM, then washed with Di-H₂O to remove remaining salts. The filtrate was concentrated under a reduced pressure of about −80 kPa to about −90 kPa, then purified with column chromatography (1:1 Dichloromethane-hexane) to give desired Compound 4.

A solution of Compound 4 (1.0 eq) and hydrazine monohydrate (13.0 eq) in ethanol was refluxed for 4 hours. After being cooled to room temperature, the mixture was concentrated under reduced pressure. 5-10 ml of Dichloromethane was added to the residues, and then was filtered to remove non-dissolved compounds. The clear solution of dichloromethane was concentrated under reduced pressure to give desired compound ML-2.

50 mg/ml ITO nanoparticles were subsequently dispersed into a trimesic acid/ethanol solution (2.1 g in 50 ml) under sonication. The mixture was kept at room temperature for 3 days under gentle stirring. Then the ITO nanoparticles were collected by centrifugation (10000 rpm, 10 min) and repeated washing with acetonitrile under sonication. The samples were finally dried under lyophilization to give ITO nanoparticles with carboxyl groups modification (COOH-ITO).

40 mg COOH-ITO nanoparticles were dispersed in dichloromethane (5 ml) under sonication. Then 80 mg of ML-2 together with 720 mg dicyclohexyl carbodiimide and 144 mg 4-dimethylaminopyridine were added under stirring. The resulting solution was stirred under room temperature for 3 days for coupling. The mixture then was diluted with dichloromethane, and centrifuged (10000 rpm, 10 min) to separate nanoparticles. The nanoparticles were washed with dichloromethane many times until excess unreacted chemicals were removed. The mesogenic ligands modified ITO nanoparticles (ML-2-ITO, or ML-ITO) were obtained after freeze-drying.

### Synthesis of Mesogenic Ligands (ML-8):

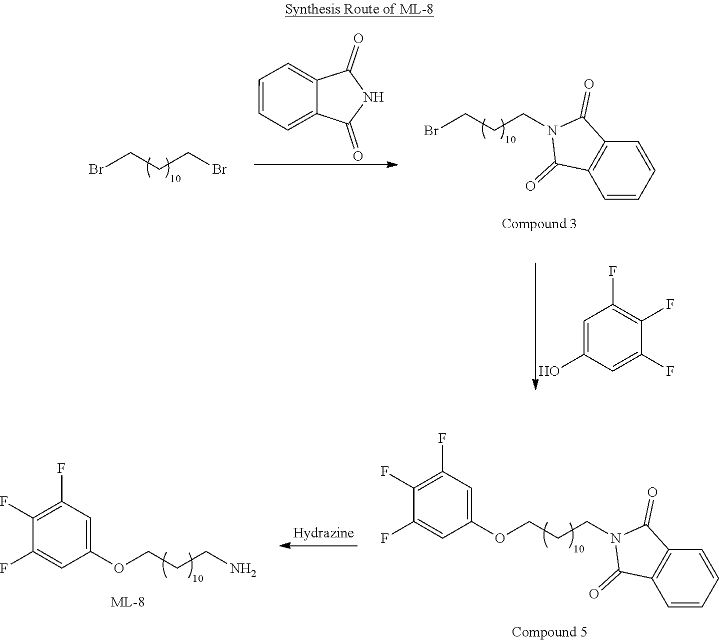

Phthalimide (1.0 eq), 1,12-Dibromododecane (3.0 eq) and K₂CO₃ (3.0 eq) were placed in a one neck round bottom flask with acetone under stirring. The resulting suspension was heated at reflux for over 20 hours, then was concentrated under vacuum. The obtained solid was dispersed in DCM, then washed with Di-H₂O to remove remaining salts. The filtrate was concentrated under reduced pressure, then purified with column chromatography (1:3 ethyl acetate-hexane) to give desired Compound 3.

Compound 3 (1.0 eq), 3,4,5-Trifluorophenol (1.5 eq) and K₂CO₃ (3.0 eq) were placed in a one neck round bottom flask with acetone under stirring. The resulting suspension was heated at reflux for over 20 hours, then was concentrated under vacuum. The obtained solid was dispersed in DCM, then washed with Di-H₂O to remove the remaining salts. The filtrate was concentrated under a reduced pressure of about −80 kPa to about −90 kPa, then purified with silica gel column chromatography (Dichloromethane) to give desired Compound 5.

A solution of Compound 5 (1.0 eq) and hydrazine monohydrate (13.0 eq) in ethanol was refluxed for 4 hours. After being cooled to room temperature, the mixture was concentrated under reduced pressure. 5-10 ml of Dichloromethane was added to the residues, and then was filtered to remove non-dissolved compounds. The clear solution of dichloromethane was concentrated under reduced pressure to give desired compound ML-8.

40 mg COOH-ITO nanoparticles were dispersed in dichloromethane (5 ml) under sonication. Then 80 mg of ML-8 together with 720 mg dicyclohexyl carbodiimide and 144 mg 4-dimethylaminopyridine was added under stirring. The resulting solution was stirred under room temperature for 3 days for coupling. The mixture then was diluted with dichloromethane, and centrifuged (10000 rpm, 10 min) to separate nanoparticles. The nanoparticles were washed with dichloromethane many times until excess unreacted chemicals were removed. The mesogenic ligands nanoparticles (ML-8-ITO, or FML-ITO) were obtained after freeze-drying.

### Preparation of Coatable PDLC Formulation

50 parts by weight of an aqueous aliphatic polyurethane latex (manufactured by Zeneca, trade name “Neorez@ R-967,” including 35% by weight of latex particles) is added to 50 parts by weight of a liquid crystal compound (trade name “JM1000XX”, manufactured by Chisso Corporation). After that, the mixture was stirred using an Excel auto homogenizer (manufactured by Nippon Seiki Co., Ltd.) while maintaining the stirring section at 40° C. to obtain Liquid Crystal Compound 1 (emulsified liquid crystal compound). The viscosity of the Liquid Crystal Compound 1 was 65 mPas.

### Fabrication of PDLC Light Shutter

### Preparation Process

15 mg ITO nanoparticles was weighted and added in 20 ml glass vial. 5 ml DCM was added to the ITO nanoparticles, and sonicated for 5 min to visually observe light green dispersion. 1 g of Liquid Crystal Compound 1 was added and gently stirred until fully dissolved. Then the dispersion was probe sonicated under and ice bath for better dispersion (60% amplitude, 2 s on and 2 s off, 8 min) (the parameter can be optimized based on the types of nanoparticles). Then one stirring bar was put into the mixture, and the mixture was stirred with cap open under 500 rpm overnight to evaporate solvent. The mixture was then placed under a vacuum at room temperature for 30 min-1 hour to evaporate all the solvent.

### Emulsion of LC Compound

The emulsifier stock solution is at 10% and diluted to 1% for usage. Take LC-NP mixture/1 g Liquid Crystal Compound 1 and place into a 3 ml syringe. Then take another 3 ml syringe to gather 1 ml 1% emulsifier into the syringe. Place a filter in the middle of two syringes, push and pull for 40 times to obtain Emulsified Liquid Crystal Compound 1.

### PDLC Devices Fabrication

Using a slot die (lip thickness (width) 3 mm) or Mayer Rod, the Emulsified Liquid Crystal Compound 1 is coated (applied and dried) onto the first transparent conductive film. Thus, an Emulsified Liquid Crystal layer having a thickness of 20 μm was formed. Then, a second transparent conductive film was laminated and stacked on the Emulsified Liquid Crystal layer, and the light control layer film was obtained. In addition, as a first transparent conductive film and a second transparent conductive film, the transparent conductive layer was formed which comprises of an ITO layer on a PET base material.

### Optical (Haze) Measurements:

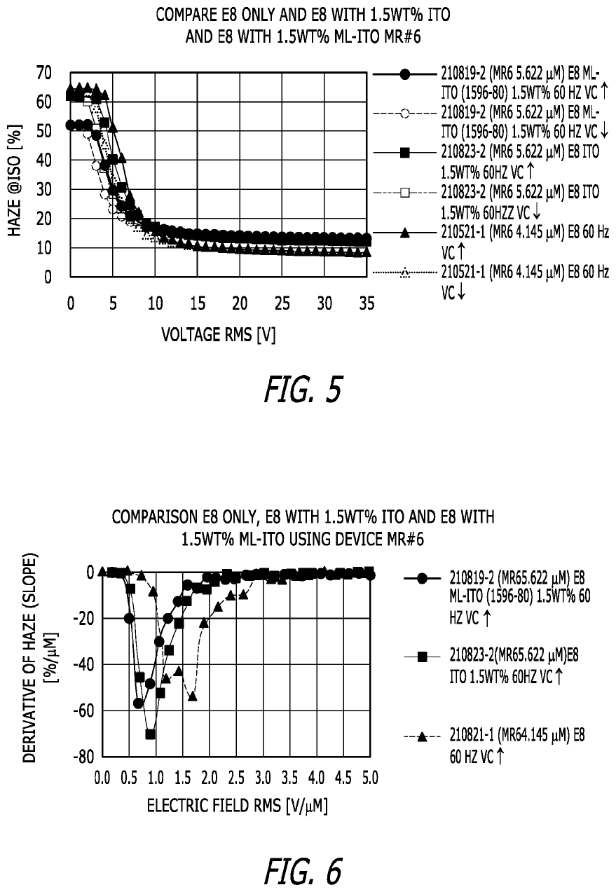

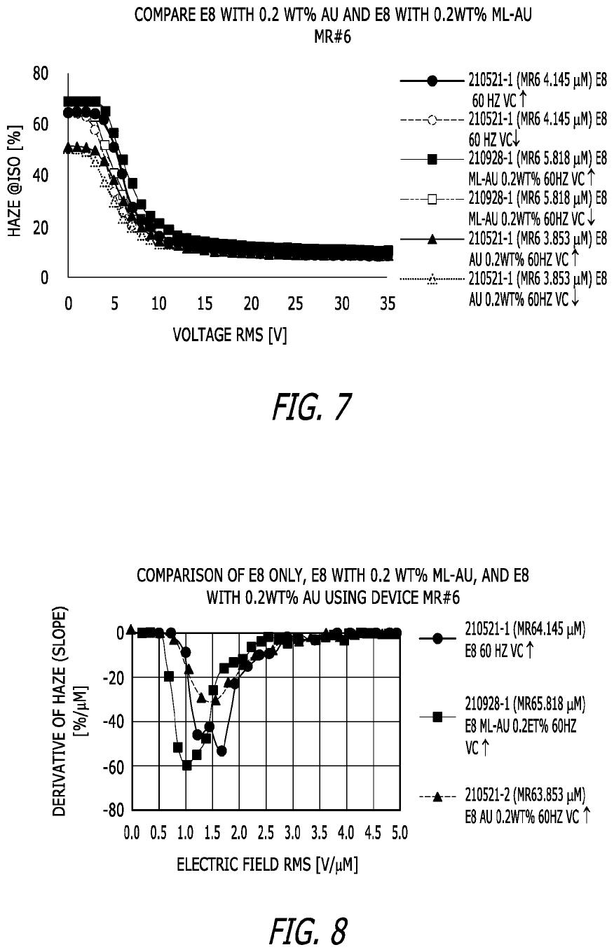

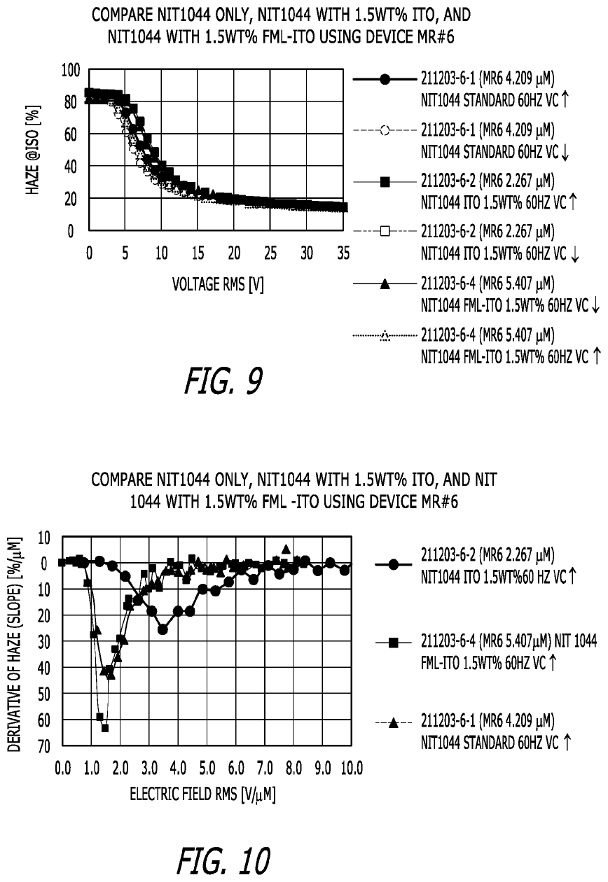

The optical characteristics of the light shutters were characterized by measuring the light allowed to pass through each fabricated shutter, both with and without an electric field present. Light transmittance data for the samples was measured using a haze meter (Nippon Denshoku NDH 7000; NDK, Japan) with each respective sample placed inside the device. The source was directly measured without any sample present to provide a baseline measurement of total light transmitted. Then, the samples were placed directly in the optical path, such that the emitted light passes through the samples. Then the sample was placed into the haze meter, with the sample connected to a voltage source (3PN117C Variable Transformer; Superior Electric, Farmington, CT, USA) via electrical wires, one wire connected to each terminal and to a respective ITO glass substrate on the device such that an electric field would be applied across the device when a voltage source is energized, or a voltage applied. Then, the emitted light transmitted through the samples was measured, at first with no voltage applied and then again at various magnitudes of voltage, ranging from 0 volts up to 60 volts with measurements taken in 5-volt increments; with haze measurements taken at differing times. FIGS. 5-10 depict a curve of the haze level against applied voltage for various examples.

1. A light shutter comprising:
a first base element with a transparent electrode layer;
a second base element with a transparent electrode layer; and
a polymer matrix comprising a mesogenic ligand nanoparticle complex and a liquid crystal compound, wherein the polymer matrix is disposed between the first base element and the second base element.

2. The light shutter of claim 1, wherein the mesogenic ligand nanoparticle complex comprise an alkyl amine ligand or an aryl amine ligand.

3. The light shutter of claim 1, wherein the mesogenic ligand nanoparticle complex comprising a ligand of the general formula: 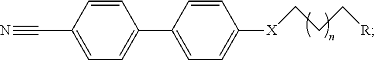
wherein X may be —O— or —S—, wherein n may be about 5 to about 15, and wherein R may be —COOH, —C═CH₂, —OH, —SH, —NH₂, or —N₃.

4. The light shutter of claim 1, wherein the mesogenic ligand nanoparticle complex comprises: 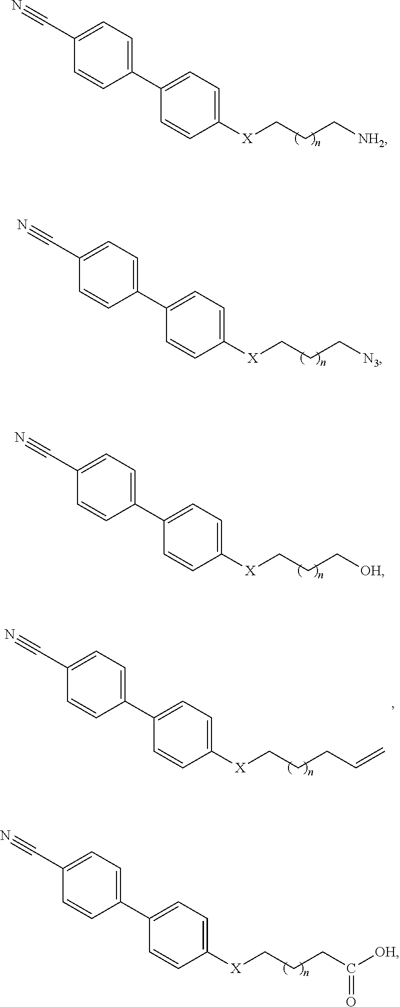
or a combination thereof; wherein n may be about 5 to about 15, and wherein X may be —O— or —S—.

5. The light shutter of claim 1, wherein the mesogenic ligand nanoparticle complex comprises: 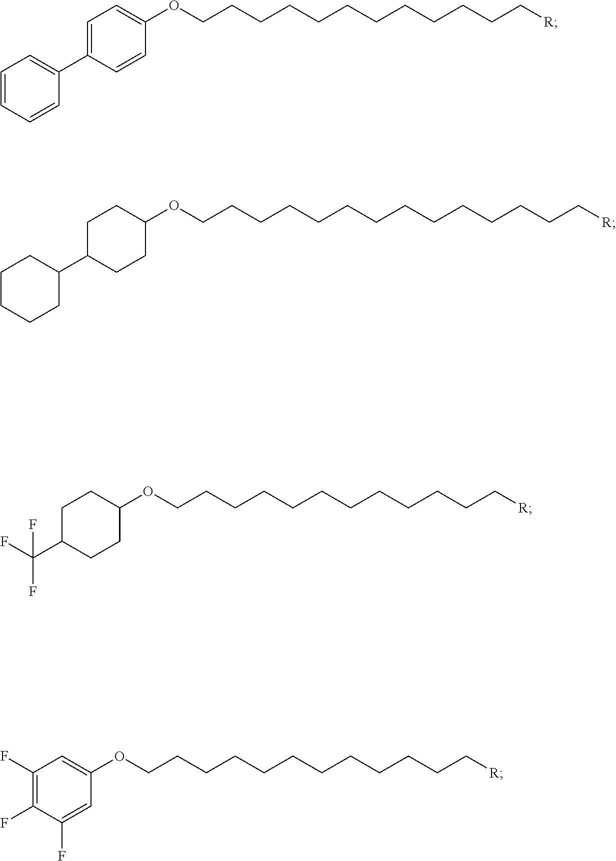
or a combination thereof, wherein R may be —COOH, —C═CH₂, —OH, —SH, —NH₂, or —N₃.

6. The light shutter of claim 1, wherein the mesogenic ligand nanoparticle complex comprises a precious metal nanoparticle.

7. The light shutter of claim 6, wherein the precious metal nanoparticle comprises a gold (Au) nanoparticle.

8. The light shutter of claim 1, wherein the mesogenic ligand nanoparticle complex comprising a semi-conductive material.

9. The light shutter of claim 8, wherein the semi-conductive material comprises an indium tin oxide (ITO) nanoparticle.

10. The light shutter of claim 1, wherein the concentration of the mesogenic ligand nanoparticle complex is about 0.01 wt % to about 5 wt % of the total weight of the polymer matrix.

11. The light shutter of claim 1, wherein the polymer matrix further comprises a spacer compound.

12. The light shutter of claim 11, wherein the spacer compound comprises an alkyl amine spacer or an alkyl thiol spacer, wherein the relative amount of the alkyl amine spacer to the mesogenic ligand nanoparticle complex, or the alkyl thiol spacer to mesogenic ligand nanoparticle complex, is about 2:1 to about 1:2.

13. The light shutter of claim 1, wherein the liquid crystal compound comprises a polymer dispersed liquid crystal.

14. The light shutter of claim 1, wherein the liquid crystal compound comprises an emulsified polymer dispersed liquid crystal.

15. The light shutter of claim 1, wherein the liquid crystal compound comprises a resin.
